(19) United States
(12) Patent Application Publication
(10) Pub. No.: US 2026/0035029 A1
(43) Pub. Date: Feb. 5, 2026

(54) STEERING WHEEL DEVICE WITH HANDS-OFF DETECTION (HOD)

(71) Applicant: PIXART IMAGING INC., HSIN-CHU (TW)

(72) Inventors: MING-HUNG TSAI, HSIN-CHU (TW); TSE-CHUNG SU, HSIN-CHU (TW); TZU-CHING WANG, HSIN-CHU (TW); TZUNG-MIN SU, HSIN-CHU (TW)

(21) Appl. No.: 18/792,502

(22) Filed: Aug. 1, 2024

(51) Int. Cl. B62D 1/04; G01D 5/14

(52) U.S. Cl. CPC B62D 1/04; G01D 5/14

(57) ABSTRACT

A steering wheel device with hands-off detection (HOD) includes a steering wheel and a holding sensing module assembled to the steering wheel. The steering wheel includes a left holding segment and a right holding segment. The holding sensing module includes a first sensing electrode and a second sensing electrode facing toward and spaced apart from each other. The first sensing electrode has a plurality of first parts each having a first width. The first widths of the first parts are different from each other and gradually decrease in a first direction from the left holding segment toward the right holding segment. The second sensing electrode has a plurality of second parts each having a second width. The second widths of the second parts are different from each other and gradually increase in the first direction from the left holding segment toward the right holding segment.

### FIELD OF THE DISCLOSURE

The present disclosure relates to a steering wheel, and more particularly to a steering wheel device with hands-off detection (HOD).

### BACKGROUND OF THE DISCLOSURE

A conventional steering wheel is provided with a sensing function for providing a hands-off detection (HOD) technology for a driver. However, the sensing function of the conventional steering wheel is not enough to distinguish different orientations or positions in which the driver may hold the conventional steering wheel.

### SUMMARY OF THE DISCLOSURE

In response to the above-referenced technical inadequacy, the present disclosure provides a steering wheel device with hands-off detection (HOD) for effectively improving on the issues associated with conventional steering wheels.

In order to solve the above-mentioned problems, one of the technical aspects adopted by the present disclosure is to provide a steering wheel device with hands-off detection (HOD), which includes a steering wheel and a holding sensing module. The steering wheel has a manipulation ring defining a central axis, and the manipulation ring includes a left holding segment and a right holding segment. The holding sensing module is assembled to the steering wheel and includes a first sensing electrode and a second sensing electrode. The first sensing electrode has a plurality of first parts and is disposed on the manipulation ring. Each of the first parts of the first sensing electrode has a first width, and the first widths of the first parts are different from each other and gradually decrease in a first direction from the left holding segment toward the right holding segment. The second sensing electrode has a plurality of second parts and is disposed on the manipulation ring. Each of the second parts of the second sensing electrode has a second width, and the second widths of the second parts are different from each other and gradually increase in the first direction from the left holding segment toward the right holding segment. The first sensing electrode and the second sensing electrode face toward each other and are spaced apart from each other through an elongated gap therebetween. In any two of longitudinal cross sections of the holding sensing module each covering the central axis, the two first widths are different from each other, and the two second widths are different from each other.

In one of the possible or preferred embodiments, in any one of the longitudinal cross sections, each of the first sensing electrode and the second sensing electrode has a circular shape having a center of circle that is located in the manipulation ring.

In one of the possible or preferred embodiments, in a transverse cross section of the holding sensing module perpendicular to the central axis, the first sensing electrode has a first central angle relative to the central axis, and the second sensing electrode has a second central angle relative to the central axis. Moreover, a difference between the first central angle and the second central angle is less than or equal to 5 degrees.

In one of the possible or preferred embodiments, the first central angle is within a range from 180 degrees to 360 degrees.

In one of the possible or preferred embodiments, the first sensing electrode has a slanting edge facing toward the second sensing electrode, and the slanting edge and the transverse cross section have an arrangement angle therebetween that is within a range from 0 degrees to 45 degrees.

In one of the possible or preferred embodiments, the first parts of the first sensing electrode are integrally formed as a single one-piece structure having an elongated shape, the second parts of the second sensing electrode are integrally formed as a single one-piece structure having an elongated shape, and a thickness of the first sensing electrode is equal to a thickness of the second sensing electrode.

In order to solve the above-mentioned problems, another one of the technical aspects adopted by the present disclosure is to provide a steering wheel device with hands-off detection (HOD), which includes a steering wheel and a holding sensing module. The steering wheel has a manipulation ring defining a central axis, and the manipulation ring includes a left holding segment and a right holding segment. The holding sensing module is assembled to the steering wheel and includes a plurality of left sensing electrodes and a plurality of right sensing electrodes. Each of the left sensing electrodes has an elongated shape and is disposed on the left holding segment of the manipulation ring. The left sensing electrodes include a plurality of first left electrodes and a plurality of second left electrodes that are staggered with the first left electrodes. Moreover, a width of each of the first left electrodes is different from a width of any one of the second left electrodes. Each of the right sensing electrodes has an elongated shape and is disposed on the right holding segment of the manipulation ring. The right sensing electrodes include a plurality of first right electrodes and a plurality of second right electrodes that are staggered with the first right electrodes. Moreover, a width of each of the first right electrodes is different from a width of any one of the second right electrodes. The first left electrodes are electrically coupled to the second right electrodes, respectively, and the width of each of the first left electrodes is different from the width of the corresponding second right electrodes. The second left electrodes are electrically coupled to the first right electrodes, respectively, and the width of each of the second left electrodes is different from the width of the corresponding first right electrodes.

In one of the possible or preferred embodiments, the width of each of the first left electrodes is equal to the width of any one of the first right electrodes, and the width of each of the second left electrodes is equal to the width of any one of the second right electrodes.

In one of the possible or preferred embodiments, in a longitudinal cross section covering the central axis and passing through the left sensing electrodes, each of the left sensing electrodes has a circular shape having a center of circle that is located in the manipulation ring. Moreover, in a longitudinal cross section covering the central axis and passing through the right sensing electrodes, each of the right sensing electrodes has a circular shape having a center of circle that is located in the manipulation ring.

In one of the possible or preferred embodiments, the manipulation ring includes an upper holding segment that connects the left holding segment and the right holding segment, and each of the left sensing electrodes is connected to the corresponding right sensing electrode to form a connection interface that is located on the upper holding segment.

In one of the possible or preferred embodiments, the connection interface of each of the left sensing electrodes and the corresponding right sensing electrode is located at a center portion of the upper holding segment.

In one of the possible or preferred embodiments, in a transverse cross section of the holding sensing module perpendicular to the central axis, each of the left sensing electrodes has a first central angle relative to the central axis, and each of the right sensing electrodes has a second central angle relative to the central axis. Moreover, a difference between the first central angle and the second central angle is less than or equal to 5 degrees.

In one of the possible or preferred embodiments, the first central angle is within a range from 90 degrees to 180 degrees.

In one of the possible or preferred embodiments, the manipulation ring includes an upper holding segment that connects the left holding segment and the right holding segment, the holding sensing module includes a plurality of upper sensing electrodes having a same width. Moreover, each of the upper sensing electrodes has an elongated shape and is disposed on the upper holding segment of the manipulation ring. Furthermore, each of the left sensing electrodes and the corresponding right sensing electrode are electrically coupled to each other through one of the upper sensing electrodes.

In one of the possible or preferred embodiments, in a transverse cross section of the holding sensing module perpendicular to the central axis, each of the left sensing electrodes has a first central angle relative to the central axis, each of the right sensing electrodes has a second central angle relative to the central axis, and each of the upper sensing electrodes has a third central angle relative to the central axis. Moreover, a difference between the first central angle and the second central angle is less than or equal to 5 degrees.

In one of the possible or preferred embodiments, in a transverse cross section of the holding sensing module perpendicular to the central axis, each of the left sensing electrodes has a first central angle relative to the central axis, each of the right sensing electrodes has a second central angle relative to the central axis, and each of the upper sensing electrodes has a third central angle relative to the central axis. Moreover, in this embodiment, the first central angle is within a range from 60 degrees to 180 degrees, and the third central angle is within a range from 60 degrees to 180 degrees.

In order to solve the above-mentioned problems, yet another one of the technical aspects adopted by the present disclosure is to provide a steering wheel device with hands-off detection (HOD), which includes a steering wheel and a holding sensing module. The steering wheel has a manipulation ring defining a central axis, and the manipulation ring includes a left holding segment and a right holding segment. The holding sensing module is assembled to the steering wheel and includes a plurality of left sensing electrodes, a plurality of left bridge electrodes, a plurality of right sensing electrodes, and a plurality of right bridge electrodes. Each of the left sensing electrodes has an elongated shape and is disposed on the left holding segment of the manipulation ring. The left sensing electrodes have a same width and are staggered with each other. Each of the left bridge electrodes is connected in-between two of the left sensing electrodes adjacent to each other so as to be jointly defined as one of a plurality of first left electrodes, and any one of the left sensing electrodes not connected to any one of the left bridge electrodes is defined as one of a plurality of second left electrodes. Any two of the first left electrodes adjacent to each other are provided with one of the second left electrodes therebetween. Each of the right sensing electrodes has an elongated shape and is disposed on the right holding segment of the manipulation ring. The right sensing electrodes have a same width and are staggered with each other. Each of the right bridge electrodes is connected in-between two of the right sensing electrodes adjacent to each other so as to be jointly defined as one of a plurality of first right electrodes, and any one of the right sensing electrodes not connected to any one of the right bridge electrodes is defined as one of a plurality of second right electrodes. Any two of the first right electrodes adjacent to each other are provided with one of the second right electrodes therebetween. The first left electrodes are respectively connected to the second right electrodes, and the second left electrodes are respectively connected to the first right electrodes.

In one of the possible or preferred embodiments, in a transverse cross section of the holding sensing module perpendicular to the central axis, each of the left sensing electrodes has a first central angle relative to the central axis, and each of the right sensing electrodes has a second central angle relative to the central axis. Moreover, a difference between the first central angle and the second central angle is less than or equal to 5 degrees.

In one of the possible or preferred embodiments, in a transverse cross section of the holding sensing module perpendicular to the central axis, each of the left sensing electrodes has a first central angle relative to the central axis, and each of the right sensing electrodes has a second central angle relative to the central axis. Moreover, in this embodiment, the first central angle is within a range from 90 degrees to 270 degrees.

In one of the possible embodiments, in each of the first left electrodes, a length of the left bridge electrode is within a range from 0.01% to 10% of a length of any one of the two left sensing electrodes. Moreover, in each of the first right electrodes, a length of the right bridge electrode is within a range from 0.01% to 10% of a length of any one of the two right sensing electrodes.

Therefore, in the steering wheel device of the present disclosure, the holding sensing module on the steering wheel is provided with the sensing electrodes under specific conditions (e.g., the cooperation of the first sensing electrode and the second sensing electrode; or, the cooperation of the left sensing electrodes and the right sensing electrodes; or, the cooperation of the left sensing electrodes, the left bridge electrodes, the right sensing electrodes, and the right bridge electrodes), so that the position by the driver on the steering wheel device held can be precisely detected through the holding sensing module.

Specifically, when the driver grips any position of the steering wheel device, areas of the sensing electrodes held by the driver have a ratio therebetween being different from that of other positions of the steering wheel device, thereby enabling the position of the steering wheel device held by the driver to be precisely detected.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a steering wheel device with hands-off detection (HOD) according to a first embodiment of the present disclosure;

FIG. 2 is a schematic planar view showing a holding sensing module of FIG. 1 that is unwrapped in a flat mode;

FIG. 3 is a schematic planar view showing the holding sensing module of FIG. 1 in another configuration that is unwrapped in a flat mode;

FIG. 4 is a schematic front view of FIG. 1;

FIG. 5 is a schematic rear view of FIG. 1;

FIG. 6 is a schematic cross-sectional view taken along line VI-VI of FIG. 4;

FIG. 7 is a schematic cross-sectional view taken along line VII-VII of FIG. 4;

FIG. 8 is a schematic perspective view of the steering wheel device with HOD according to a second embodiment of the present disclosure;

FIG. 9 is a schematic planar view showing the holding sensing module of FIG. 8 that is unwrapped in a flat mode;

FIG. 10 is a schematic front view of FIG. 8;

FIG. 11 is a schematic cross-sectional view taken along line XI-XI of FIG. 10;

FIG. 12 is a schematic cross-sectional view taken along line XII-XII of FIG. 10;

FIG. 13 is a schematic perspective view of the steering wheel device with HOD according to a third embodiment of the present disclosure;

FIG. 14 is a schematic planar view showing the holding sensing module of FIG. 13 that is unwrapped in a flat mode;

FIG. 15 is a schematic front view of FIG. 13;

FIG. 16 is a schematic cross-sectional view taken along line XVI-XVI of FIG. 15;

FIG. 17 is a schematic perspective view of the steering wheel device with HOD according to a fourth embodiment of the present disclosure;

FIG. 18 is a schematic planar view showing the holding sensing module of FIG. 17 that is unwrapped in a flat mode; and

FIG. 19 is a schematic front view of FIG. 17.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

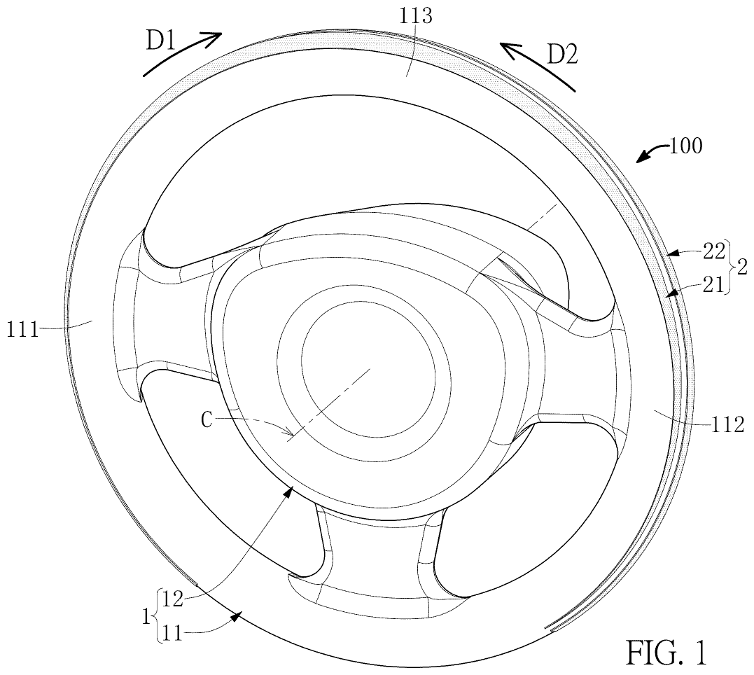

Referring to FIG. 1 to FIG. 7, a first embodiment of the present disclosure is provided. As shown in FIG. 1, the present embodiment provides a steering wheel device 100 with hands-off detection (HOD), which is suitable to be assembled to a vehicle (not shown in the drawings) for providing a driver to control and change a movement direction of the vehicle. The steering wheel device 100 includes a steering wheel 1 and a holding sensing module 2 that is assembled to the steering wheel 1.

The steering wheel 1 includes a manipulation ring 11 and an electrical control area 12 that is arranged inside of the manipulation ring 11. The manipulation ring 11 defines a central axis C. Specifically, the manipulation ring 11 in the present embodiment is circular ring-shaped and includes a left holding segment 111, a right holding segment 112, and an upper holding segment 113 that connects the left holding segment 111 and the right holding segment 112, but the present disclosure is not limited thereto.

For example, in other embodiments of the present disclosure not shown in the drawings, the shape of the manipulation ring 11 can be adjusted or changed according to practical requirements (e.g., the manipulation ring 11 can have a non-circular ring-shape, and the upper holding segment 113 can be omitted or can have a straight shape). Furthermore, in other embodiments of the present disclosure not shown in the drawings, the steering wheel 1 can further include other components that are disposed on the manipulation ring 11 to shield the holding sensing module 2.

As shown in FIG. 1 to FIG. 3, the holding sensing module 2 includes a first sensing electrode 21 and a second sensing electrode 22. The first sensing electrode 21 and the second sensing electrode 22 are spaced apart from each other and are disposed on the manipulation ring 11. Moreover, in this embodiment, a thickness of the first sensing electrode 21 is equal to a thickness of the second sensing electrode 22, and the first sensing electrode 21 and the second sensing electrode 22 face toward each other and are spaced apart from each other through an elongated gap G therebetween, but the present disclosure is not limited thereto. For example, in other embodiments of the present disclosure not shown in the drawings, the thickness of the first sensing electrode 21 can be different from the thickness of the second sensing electrode 22.

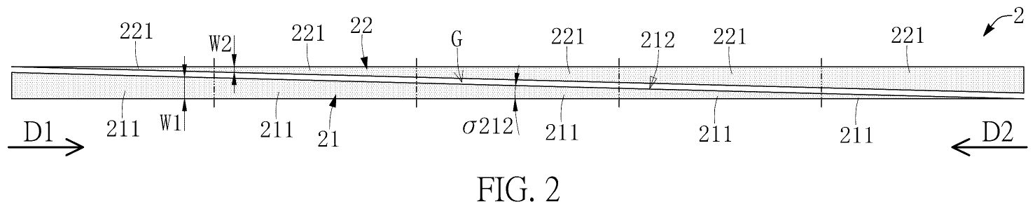

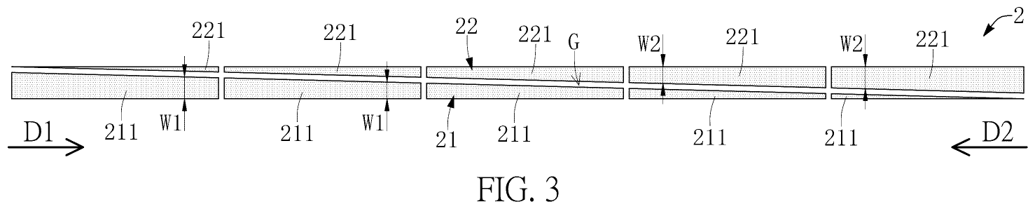

It should be noted that the first sensing electrode 21 has a plurality of first parts 211, the second sensing electrode 22 has a plurality of second parts 221, and the specific arrangement of the first parts 211 and the second parts 221 can be adjusted or changed according to practical requirements. For example, as shown in FIG. 2, the first parts 211 of the first sensing electrode 21 can be integrally formed as a single one-piece structure having an elongated shape, and the second parts 221 of the second sensing electrode 22 can be integrally formed as a single one-piece structure having an elongated shape. Or, as shown in FIG. 3, the first parts 211 can be spaced apart from each other along the manipulation ring 11, and the second parts 221 can be spaced apart from each other along the manipulation ring 11.

As shown in FIG. 2 and FIG. 4 to FIG. 7, the first parts 211 of the first sensing electrode 21 in the present embodiment are sequentially arranged along the left holding segment 111, the upper holding segment 113, and the right holding segment 112. Moreover, each of the first parts 211 of the first sensing electrode 21 has a first width W1, and the first widths W1 of the first parts 211 are different from each other and gradually decrease in a first direction D1 from the left holding segment 111 toward the right holding segment 112.

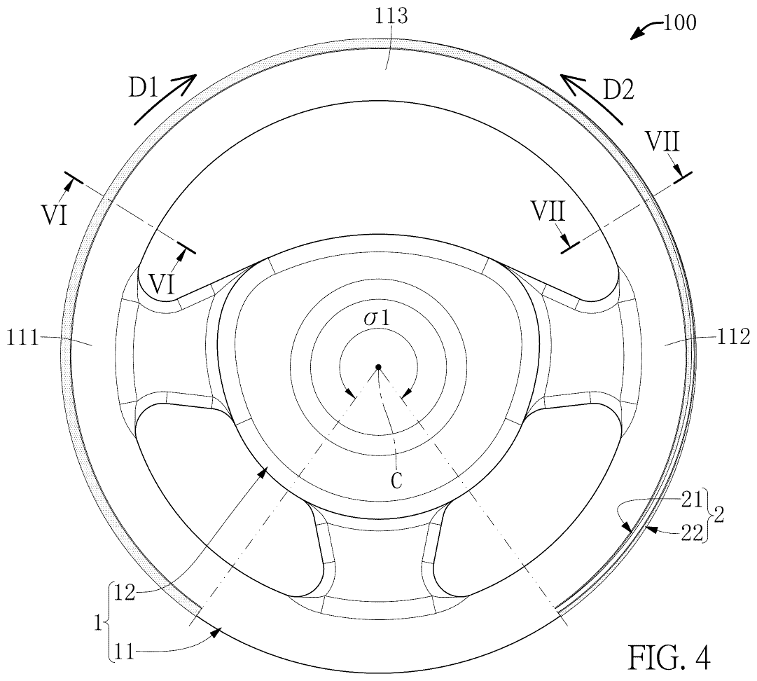

The first direction D1 is defined as a counterclockwise direction shown in FIG. 4, and a clockwise direction shown in FIG. 4 is defined as a second direction D2 that is opposite to the first direction D1. In other words, the first widths W1 of the first parts 211 gradually increase in the second direction D2 from the right holding segment 112 toward the left holding segment 111. In addition, an outer contour of the first sensing electrode 21 in the present embodiment has a triangular shape, but the present disclosure is not limited thereto.

The second parts 221 of the second sensing electrode 22 in the present embodiment are sequentially arranged along the left holding segment 111, the upper holding segment 113, and the right holding segment 112. Moreover, each of the second parts 221 of the second sensing electrode 22 has a second width W2, and the second widths W2 of the second parts 221 are different from each other and gradually increase in the first direction D1 from the left holding segment 111 toward the right holding segment 112. In other words, the second widths W2 of the second parts 221 gradually decrease in the second direction D2 from the right holding segment 112 toward the left holding segment 111. In addition, an outer contour of the second sensing electrode 22 in the present embodiment has a triangular shape, but the present disclosure is not limited thereto.

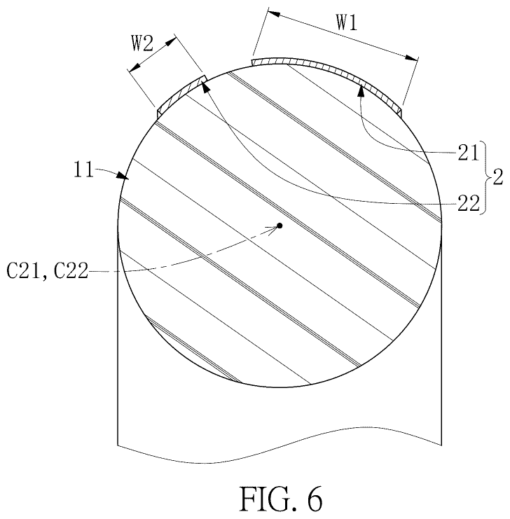

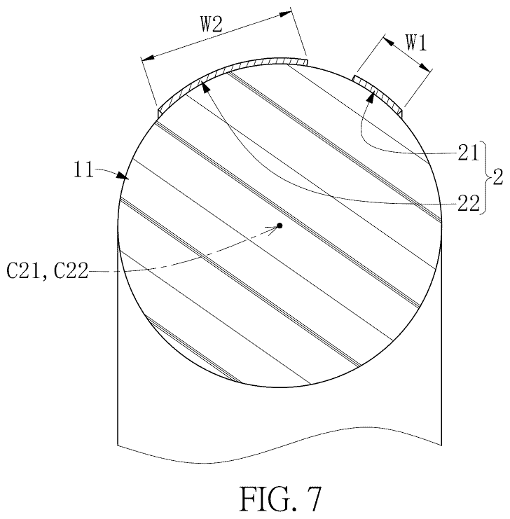

In any two of longitudinal cross sections of the holding sensing module 2 each covering the central axis C (as shown in FIG. 6 and FIG. 7), the two first widths W1 are different from each other, and the two second widths W2 are different from each other. Moreover, in any one of the longitudinal cross sections, each of the first sensing electrode 21 and the second sensing electrode 22 has a circular shape having a center of circle C21, C22 that is located in the manipulation ring 11.

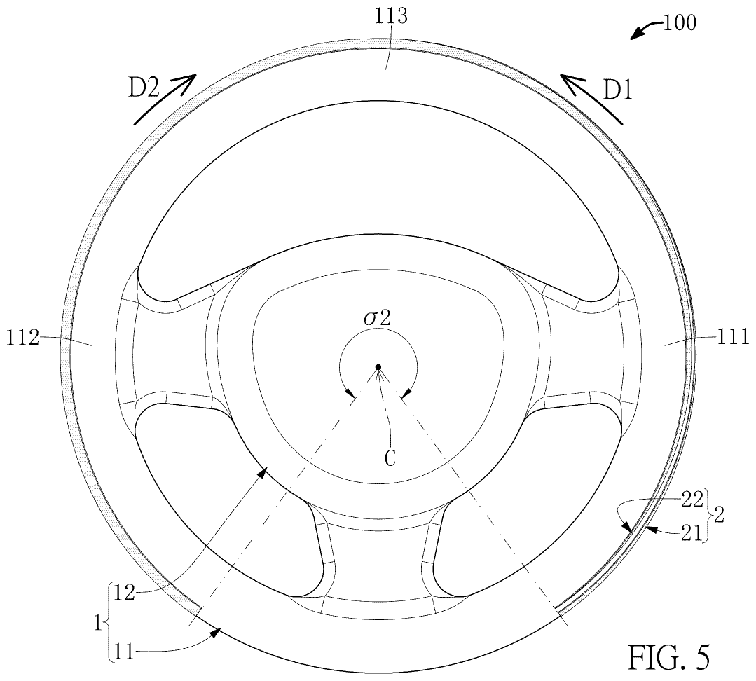

As shown in FIG. 4 and FIG. 5, in a transverse cross section of the holding sensing module 2 being perpendicular to the central axis C, the first sensing electrode 21 has a first central angle σ1 relative to the central axis C, and the second sensing electrode 22 has a second central angle σ2 relative to the central axis C. Specifically, in this embodiment, a difference between the first central angle σ1 and the second central angle σ2 is less than or equal to 5 degrees, and the first central angle σ1 is within a range from 180 degrees to 360 degrees, but the present disclosure is not limited thereto.

For clearly illustrating the present embodiment, the first sensing electrode 21 and the second sensing electrode 22 can be unwrapped in a flat mode as shown in FIG. 2. Moreover, the first sensing electrode 21 has a slanting edge 212 facing toward the second sensing electrode 22, and the slanting edge 212 and the transverse cross section have an arrangement angle σ212 (as shown in FIG. 2) therebetween that is within a range from 0 degrees to 45 degrees, but the present disclosure is not limited thereto.

In summary, in the steering wheel device 100 of the present embodiment, the holding sensing module 2 on the steering wheel 1 is provided with the first sensing electrode 21 and the second sensing electrode 22 under specific conditions (e.g., the first widths W1 of the first parts 211 gradually decrease in a first direction D1, and the second widths W2 of the second parts 221 gradually increase in the first direction D1), so that the position by the driver on the steering wheel device 100 can be precisely detected through the holding sensing module 2.

Specifically, when the driver grips any position of the steering wheel device 100 (e.g., any one of the left holding segment 111, the upper holding segment 113, and the right holding segment 112), an area of the first sensing electrode 21 and an area of the second sensing electrode 22 held by the driver have a ratio therebetween being different from that of other positions of the steering wheel device, thereby enabling the position of the steering wheel device 100 held by the driver to be precisely detected.

### Second Embodiment

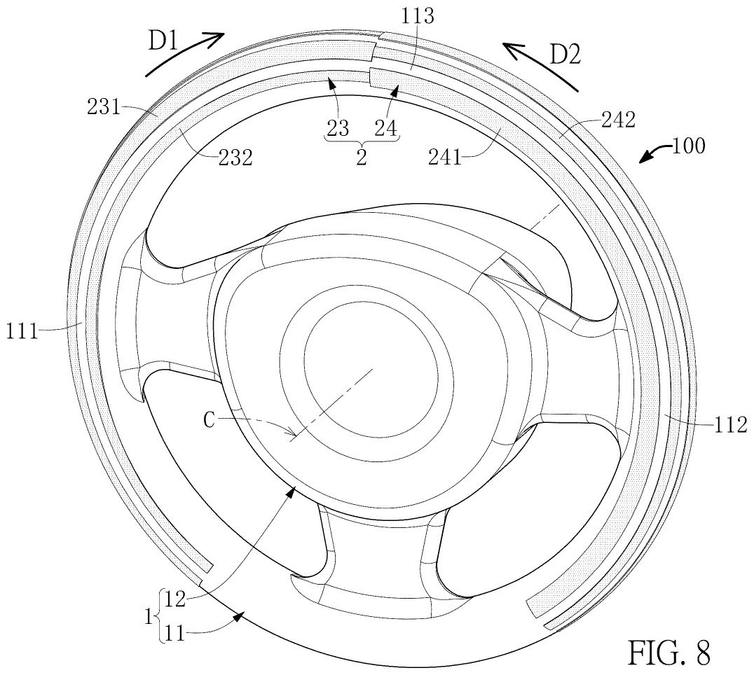

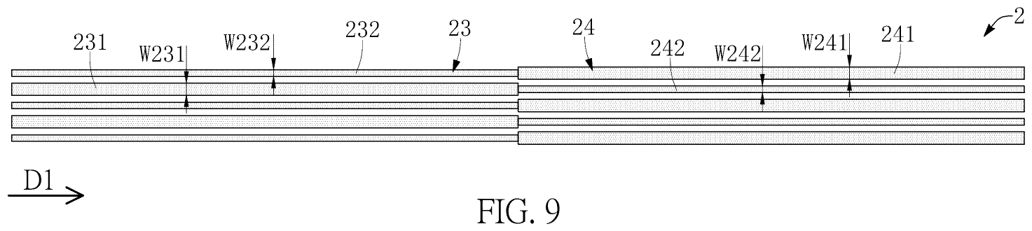

Referring to FIG. 8 to FIG. 12, a second embodiment of the present disclosure, which is similar to the first embodiment of the present disclosure, is provided. For the sake of brevity, descriptions of the same components (e.g., the steering wheel 1) in the first and second embodiments of the present disclosure will be omitted herein, and the following description only discloses different features between the first and second embodiments.

In the present embodiment, the holding sensing module 2 includes a plurality of left sensing electrodes 23 spaced apart from each other and a plurality of right sensing electrodes 24 that are spaced apart from each other. Each of the left sensing electrodes 23 has an elongated shape (e.g., a rectangular shape) and is disposed on the left holding segment 111 of the manipulation ring 11. Each of the right sensing electrodes 24 has an elongated shape (e.g., a rectangular shape) and is disposed on the right holding segment 112 of the manipulation ring 11. Each of the left sensing electrodes 23 corresponds in position to one of the right sensing electrodes 24 along the first direction D.

Moreover, the left sensing electrodes 23 and the right sensing electrodes 24 are provided with the same thickness, but the present disclosure is not limited thereto. For example, in other embodiments of the present disclosure not shown in the drawings, the thickness of any one of the left sensing electrodes 23 can be different from the thickness of one of the right sensing electrodes 24.

In the present embodiment, each of the left sensing electrodes 23 is connected to the corresponding right sensing electrode 24 at the upper holding segment 113, and the connection position of each of the left sensing electrodes 23 and the corresponding right sensing electrode 24 is located at a center portion of the upper holding segment 113, but the present disclosure is not limited thereto. For example, in other embodiments of the present disclosure not shown in the drawings, each of the left sensing electrodes 23 can be spaced apart from the corresponding right sensing electrode 24; or, the connection position of each of the left sensing electrodes 23 and the corresponding right sensing electrode 24 can be located at a left portion or a right portion of the upper holding segment 113.

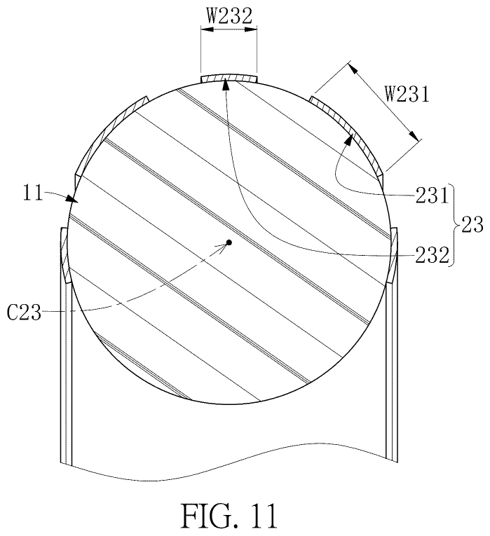

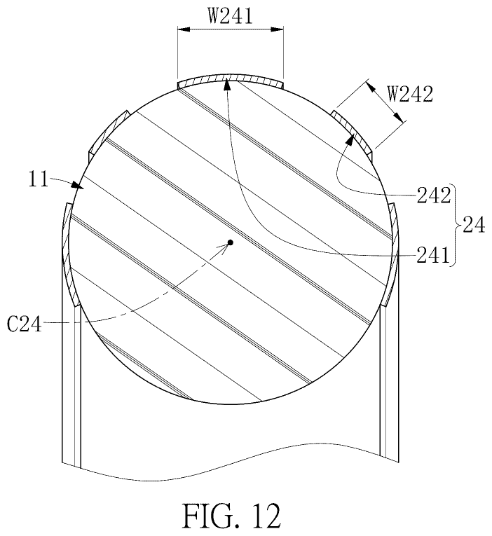

In other words, as shown in FIG. 11, in a longitudinal cross section covering the central axis C and passing through the left sensing electrodes 23, each of the left sensing electrodes 23 has a circular shape having a center of circle C23 that is located in the manipulation ring 11. Moreover, as shown in FIG. 12, in a longitudinal cross section covering the central axis C and passing through the right sensing electrodes 24, each of the right sensing electrodes 24 has a circular shape having a center of circle C24 that is located in the manipulation ring 11.

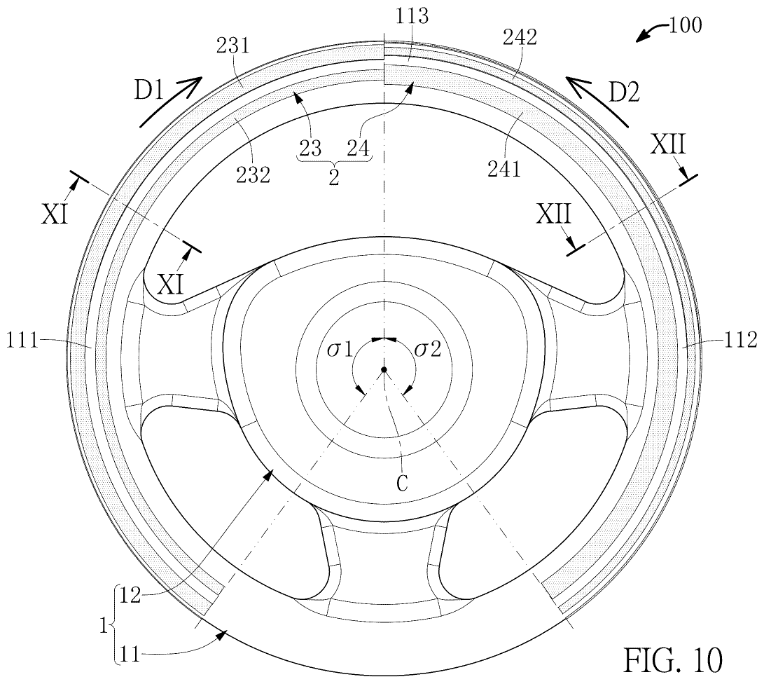

Furthermore, as shown in FIG. 10, in a transverse cross section of the holding sensing module 2 perpendicular to the central axis C, each of the left sensing electrodes 23 has a first central angle σ1 relative to the central axis C, and each of the right sensing electrodes 24 has a second central angle σ2 relative to the central axis C. Moreover, in this embodiment, a difference between the first central angle σ1 and the second central angle σ2 is less than or equal to 5 degrees, and the first central angle σ1 is within a range from 90 degrees to 180 degrees, but the present disclosure is not limited thereto.

Specifically, in order to enable the holding sensing module 2 to have a better sensing sensitivity, the left sensing electrodes 23 and the right sensing electrodes 24 are provided with the following structural features, but the present disclosure is not limited thereto.

In the present embodiment, as shown in FIG. 8 to FIG. 12, the left sensing electrodes 23 include a plurality of first left electrodes 231 and a plurality of second left electrodes 232 that are staggered with the first left electrodes 231. Specifically, a width W231 of each of the first left electrodes 231 is different from a width W232 of any one of the second left electrodes 232. The right sensing electrodes 24 include a plurality of first right electrodes 241 and a plurality of second right electrodes 242 that are staggered with the first right electrodes 241. Specifically, a width W241 of each of the first right electrodes 241 is different from a width W242 of any one of the second right electrodes 242.

Moreover, the first left electrodes 231 are electrically coupled to the second right electrodes 242, respectively, and the width W231 of each of the first left electrodes 231 is different from the width W242 of the corresponding second right electrode 242. Specifically, the first left electrodes 231 in the present embodiment are structurally connected to the second right electrodes 242, respectively. Moreover, the second left electrodes 232 are electrically coupled to the first right electrodes 241, respectively, and the width W232 of each of the second left electrodes 232 is different from the width W241 of the corresponding first right electrode 241. Specifically, the second left electrodes 232 in the present embodiment are structurally connected to the first right electrodes 241, respectively.

In the present embodiment, the width W231 of each of the first left electrodes 231 is equal to the width W241 of any one of the first right electrodes 241, and the width W232 of each of the second left electrodes 232 is equal to the width W242 of any one of the second right electrodes 242, but the present disclosure is not limited thereto.

In summary, in the steering wheel device 100 of the present embodiment, the holding sensing module 2 on the steering wheel 1 is provided with the left sensing electrode 23 and the right sensing electrode 24 under specific conditions (e.g., the width W231 of each of the first left electrodes 231 is different from the width W242 of the corresponding second right electrode 242, and the width W232 of each of the second left electrodes 232 is different from the width W241 of the corresponding first right electrode 241), so that the position by the driver on the steering wheel device 100 can be precisely detected through the holding sensing module 2.

### Third Embodiment

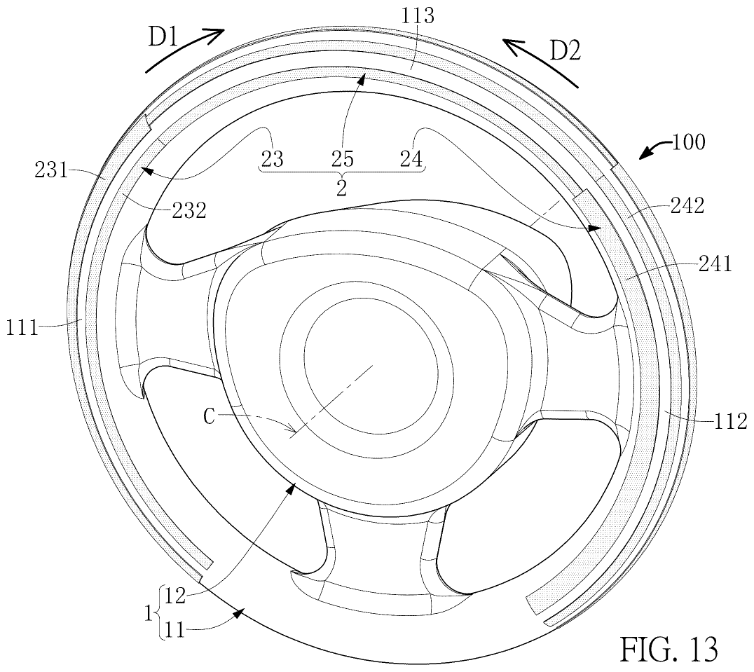

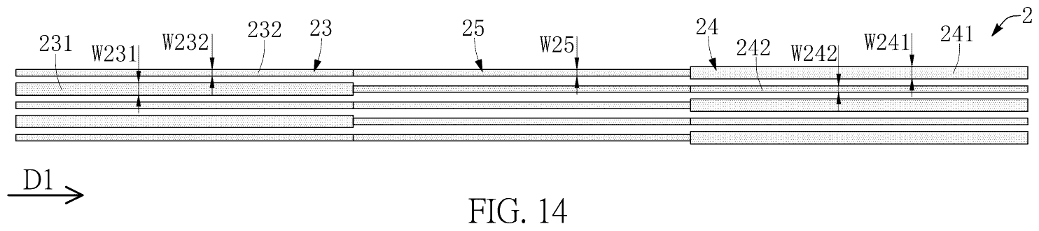

Referring to FIG. 13 to FIG. 16, a third embodiment of the present disclosure, which is similar to the second embodiment of the present disclosure, is provided. For the sake of brevity, descriptions of the same components (e.g., the steering wheel 1) in the second and third embodiments of the present disclosure will be omitted herein, and the following description only discloses different features between the second and third embodiments.

In the present embodiment, the holding sensing module 2 includes a plurality of left sensing electrodes 23, a plurality of right sensing electrodes 24, and a plurality of upper sensing electrodes 25. Each of the left sensing electrodes 23 has an elongated shape (e.g., a rectangular shape) and is disposed on the left holding segment 111 of the manipulation ring 11. Each of the right sensing electrodes 24 has an elongated shape (e.g., a rectangular shape) and is disposed on the right holding segment 112 of the manipulation ring 11. Each of the upper sensing electrodes 25 has an elongated shape (e.g., a rectangular shape) and is disposed on the upper holding segment 113 of the manipulation ring 11. Moreover, each of the left sensing electrodes 23 and the corresponding right sensing electrode 24 are electrically coupled to each other through one of the upper sensing electrodes 25 that is connected therebetween.

Specifically, the upper sensing electrodes 25 have a same width W25, and the width W25 of the upper sensing electrode 25 in the present embodiment is equal to the width W232 of the second left electrode 232 and is equal to the width W242 of the second right electrode 242, but the present disclosure is not limited thereto. For example, in other embodiments of the present disclosure not shown in the drawings, the width W25 of the upper sensing electrode 25 can be within a range from the width W232 of the second left electrode 232 and the width W241 of the first right electrode 241.

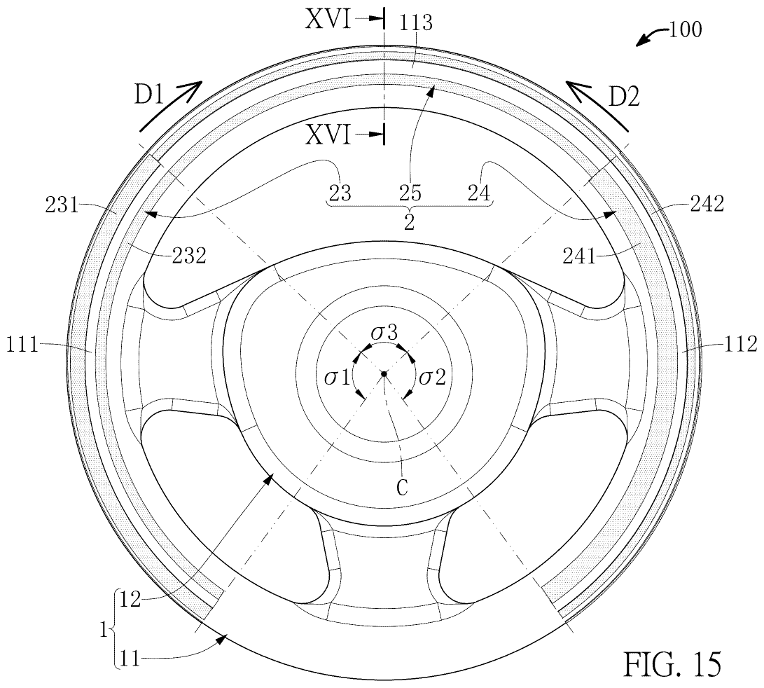

Moreover, in a transverse cross section of the holding sensing module 2 perpendicular to the central axis C (as shown in FIG. 15), each of the left sensing electrodes 23 has a first central angle σ1 relative to the central axis C, each of the right sensing electrodes 24 has a second central angle σ2 relative to the central axis C, and each of the upper sensing electrodes 25 has a third central angle σ3 relative to the central axis C. Specifically, a difference between the first central angle σ1 and the second central angle σ2 is less than or equal to 5 degrees, but the present disclosure is not limited thereto. In addition, in this embodiment, the first central angle σ1 is within a range from 60 degrees to 180 degrees, and the third central angle σ3 is within a range from 60 degrees to 180 degrees, but the present disclosure is not limited thereto.

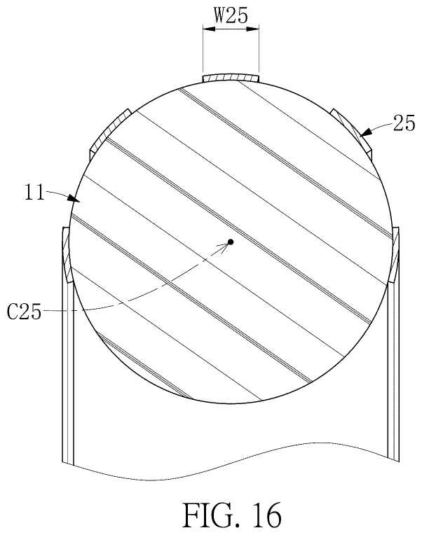

In other words, as shown in FIG. 16, in a longitudinal cross section covering the central axis C and passing through the upper sensing electrodes 25, each of the upper sensing electrodes 25 has a circular shape having a center of circle C25 that is located in the manipulation ring 11.

### Fourth Embodiment

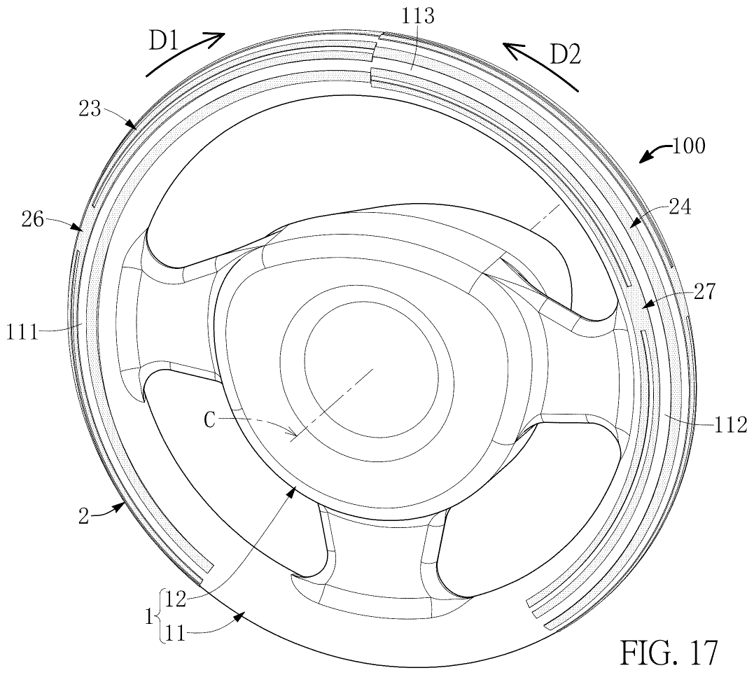

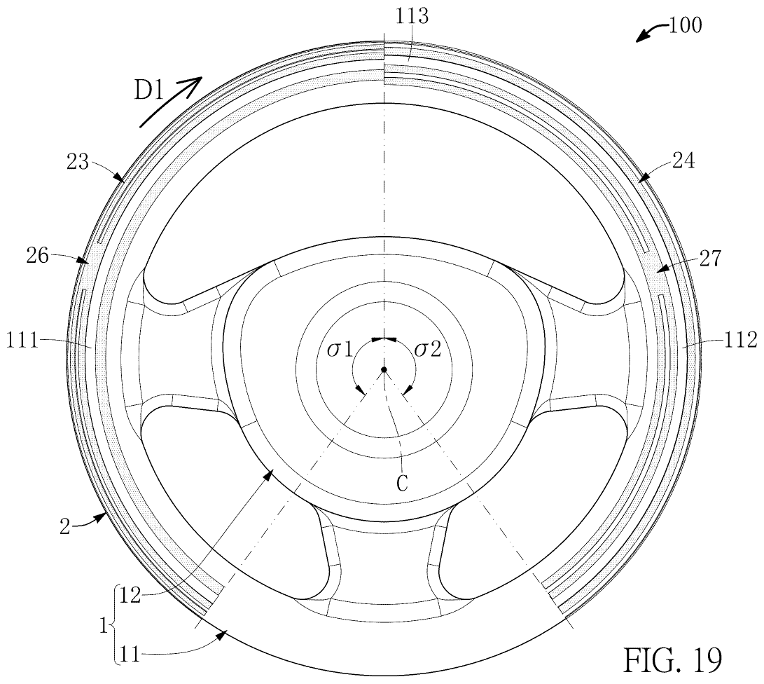

Referring to FIG. 17 to FIG. 19, a fourth embodiment of the present disclosure, which is similar to the second embodiment of the present disclosure, is provided. For the sake of brevity, descriptions of the same components (e.g., the steering wheel 1) in the second and fourth embodiments of the present disclosure will be omitted herein, and the following description only discloses different features between the second and fourth embodiments.

In the present embodiment, the holding sensing module 2 includes a plurality of left sensing electrodes 23, a plurality of left bridge electrodes 26, a plurality of right sensing electrodes 24, and a plurality of right bridge electrodes 27. Each of the left sensing electrodes 23 has an elongated shape (e.g., a rectangular shape) and is disposed on the left holding segment 111 of the manipulation ring 11, and the left sensing electrodes 23 have a same width and are spaced apart from each other. Each of the right sensing electrodes 24 has an elongated shape (e.g., a rectangular shape) and is disposed on the right holding segment 112 of the manipulation ring 11, and the right sensing electrodes 24 have a same width and are spaced apart from each other.

Moreover, in a transverse cross section of the holding sensing module 2 perpendicular to the central axis C, each of the left sensing electrodes 23 has a first central angle σ1 relative to the central axis C, and each of the right sensing electrodes 24 has a second central angle σ2 relative to the central axis C. Furthermore, a difference between the first central angle σ1 and the second central angle σ2 is less than or equal to 5 degrees, but the present disclosure is not limited thereto. In addition, in this embodiment, the first central angle σ1 is within a range from 90 degrees to 270 degrees, but the present disclosure is not limited thereto.

Specifically, each of the left bridge electrodes 26 is connected in-between two of the left sensing electrodes 23 adjacent to each other so as to be jointly defined as one of a plurality of first left electrodes 23a, and any one of the left sensing electrodes 23 not connected to any one of the left bridge electrodes 26 is defined as one of a plurality of second left electrodes 23b. In the present embodiment, any two of the first left electrodes 23a adjacent to each other are provided with one of the second left electrodes 23b therebetween. In other words, the first left electrode 231 of the second embodiment can be replaced by the left bridge electrodes 26 and the two corresponding left sensing electrodes 23 provided by the present embodiment.

Moreover, each of the right bridge electrodes 27 is connected in-between two of the right sensing electrodes 24 adjacent to each other so as to be jointly defined as one of a plurality of first right electrodes 24a, and any one of the right sensing electrodes 24 not connected to any one of the right bridge electrodes 27 is defined as one of a plurality of second right electrodes 24b. In the present embodiment, any two of the first right electrodes 24a adjacent to each other are provided with one of the second right electrodes 24b therebetween. In other words, the first right electrode 241 of the second embodiment can be replaced by the right bridge electrodes 27 and the two corresponding right sensing electrodes 24 provided by the present embodiment.

The first left electrodes 23a are respectively connected to the second right electrodes 24b, and the second left electrodes 23b are respectively connected to the first right electrodes 24a, but the present disclosure is not limited thereto. For example, in other embodiments of the present disclosure not shown in the drawings, each of the first left electrodes 23a and the corresponding second right electrodes 24b can be electrically connected to each other through one of the upper sensing electrodes 25.

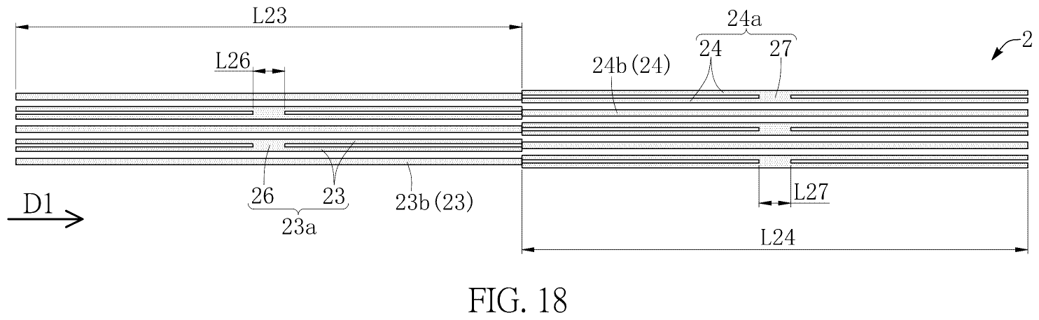

In other words, as shown in FIG. 18, in each of the first left electrodes 23a, in this embodiment, a length L26 of the left bridge electrode 26 is within a range from 0.01% to 10% of a length L23 of any one of the two left sensing electrodes 23. Moreover, in each of the first right electrodes 24a, a length L27 of the right bridge electrode 27 is within a range from 0.01% to 10% of a length L24 of any one of the two right sensing electrodes 24.

In addition, any one of the first left electrodes 23a of the present embodiment is provided with one of the left bridge electrodes 26, and any one of the first right electrodes 24a of the present embodiment is provided with one of the right bridge electrodes 27, but the present disclosure is not limited thereto. For example, in other embodiments of the present disclosure not shown in the drawings, the first left electrode 23a can be provided with more than one of the left bridge electrodes 26, and the first right electrode 24a can be provided with more than one of the right bridge electrodes 27.

Specifically, in one of embodiments of the present disclosure not shown in the drawings, the first left electrode 23a can have two left bridge electrodes 26 respectively arranged on two opposite ends thereof, and one of the two left bridge electrodes 26 is connected to the corresponding second right electrodes 24b, thereby reinforcing a structural connection therebetween. Moreover, the first right electrode 24a can have two right bridge electrodes 27 respectively arranged on two opposite ends thereof, and one of the two right bridge electrodes 27 is connected to the corresponding second left electrode 23b, thereby reinforcing a structural connection therebetween.

In addition, the material or formation of any one of the left bridge electrode 26 and the right bridge electrode 27 can be adjusted or changed according to design requirements. For example, the left bridge electrode 26 and/or the right bridge electrode 27 can be made of a conductive adhesive or a conductive binder.

### Beneficial Effects of the Embodiments

In conclusion, in the steering wheel device of the present disclosure, the holding sensing module on the steering wheel is provided with the sensing electrodes under specific conditions (e.g., the cooperation of the first sensing electrode and the second sensing electrode; or, the cooperation of the left sensing electrodes and the right sensing electrodes; or, the cooperation of the left sensing electrodes, the left bridge electrodes, the right sensing electrodes, and the right bridge electrodes), so that the position by the driver on the steering wheel device can be precisely detected through the holding sensing module.

Specifically, when the driver grips any position of the steering wheel device, areas of the sensing electrodes held by the driver have a ratio therebetween being different from that of other positions of the steering wheel device, thereby enabling the position of the steering wheel device held by the driver to be precisely detected.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A steering wheel device with hands-off detection (HOD), comprising:
a steering wheel having a manipulation ring defining a central axis, wherein the manipulation ring includes a left holding segment and a right holding segment; and
a holding sensing module assembled to the steering wheel and including:
a first sensing electrode having a plurality of first parts and disposed on the manipulation ring, wherein each of the first parts of the first sensing electrode has a first width, and the first widths of the first parts are different from each other and gradually decrease in a first direction from the left holding segment toward the right holding segment; and
a second sensing electrode having a plurality of second parts and disposed on the manipulation ring, wherein each of the second parts of the second sensing electrode has a second width, and the second widths of the second parts are different from each other and gradually increase in the first direction from the left holding segment toward the right holding segment;
wherein the first sensing electrode and the second sensing electrode face toward each other and are spaced apart from each other through an elongated gap therebetween;
wherein, in any two of longitudinal cross sections of the holding sensing module each covering the central axis, the two first widths are different from each other, and the two second widths are different from each other.

2. The steering wheel device according to claim 1, wherein, in any one of the longitudinal cross sections, each of the first sensing electrode and the second sensing electrode has a circular shape having a center of circle that is located in the manipulation ring.

3. The steering wheel device according to claim 1, wherein, in a transverse cross section of the holding sensing module perpendicular to the central axis, the first sensing electrode has a first central angle relative to the central axis, and the second sensing electrode has a second central angle relative to the central axis, and wherein a difference between the first central angle and the second central angle is less than or equal to 5 degrees.

4. The steering wheel device according to claim 1, wherein the first central angle is within a range from 180 degrees to 360 degrees.

5. The steering wheel device according to claim 1, wherein the first sensing electrode has a slanting edge facing toward the second sensing electrode, and the slanting edge and the transverse cross section have an arrangement angle therebetween that is within a range from 0 degrees to 45 degrees.

6. The steering wheel device according to claim 1, wherein the first parts of the first sensing electrode are integrally formed as a single one-piece structure having an elongated shape, the second parts of the second sensing electrode are integrally formed as a single one-piece structure having an elongated shape, and a thickness of the first sensing electrode is equal to a thickness of the second sensing electrode.

7. A steering wheel device with hands-off detection (HOD), comprising:
a steering wheel having a manipulation ring defining a central axis, wherein the manipulation ring includes a left holding segment and a right holding segment; and
a holding sensing module assembled to the steering wheel and including:
a plurality of left sensing electrodes each having an elongated shape and disposed on the left holding segment of the manipulation ring, wherein the left sensing electrodes include a plurality of first left electrodes and a plurality of second left electrodes that are staggered with the first left electrodes, and wherein a width of each of the first left electrodes is different from a width of any one of the second left electrodes; and
a plurality of right sensing electrodes each having an elongated shape and disposed on the right holding segment of the manipulation ring, wherein the right sensing electrodes include a plurality of first right electrodes and a plurality of second right electrodes that are staggered with the first right electrodes, and wherein a width of each of the first right electrodes is different from a width of any one of the second right electrodes;
wherein the first left electrodes are electrically coupled to the second right electrodes, respectively, and the width of each of the first left electrodes is different from the width of the corresponding second right electrodes; and wherein the second left electrodes are electrically coupled to the first right electrodes, respectively, and the width of each of the second left electrodes is different from the width of the corresponding first right electrodes.

8. The steering wheel device according to claim 7, wherein the width of each of the first left electrodes is equal to the width of any one of the first right electrodes, and the width of each of the second left electrodes is equal to the width of any one of the second right electrodes.

9. The steering wheel device according to claim 7, wherein, in a longitudinal cross section covering the central axis and passing through the left sensing electrodes, each of the left sensing electrodes has a circular shape having a center of circle that is located in the manipulation ring; and wherein, in a longitudinal cross section covering the central axis and passing through the right sensing electrodes, each of the right sensing electrodes has a circular shape having a center of circle that is located in the manipulation ring.

10. The steering wheel device according to claim 7, wherein the manipulation ring includes an upper holding segment that connects the left holding segment and the right holding segment, and each of the left sensing electrodes is connected to the corresponding right sensing electrode to form a connection interface that is located on the upper holding segment.

11. The steering wheel device according to claim 10, wherein the connection interface of each of the left sensing electrodes and the corresponding right sensing electrode is located at a center portion of the upper holding segment.

12. The steering wheel device according to claim 10, wherein, in a transverse cross section of the holding sensing module perpendicular to the central axis, each of the left sensing electrodes has a first central angle relative to the central axis, and each of the right sensing electrodes has a second central angle relative to the central axis, and wherein a difference between the first central angle and the second central angle is less than or equal to 5 degrees.

13. The steering wheel device according to claim 12, wherein the first central angle is within a range from 90 degrees to 180 degrees.

14. The steering wheel device according to claim 7, wherein the manipulation ring includes an upper holding segment that connects the left holding segment and the right holding segment, the holding sensing module includes a plurality of upper sensing electrodes having a same width, wherein each of the upper sensing electrodes has an elongated shape and is disposed on the upper holding segment of the manipulation ring, and wherein each of the left sensing electrodes and the corresponding right sensing electrode are electrically coupled to each other through one of the upper sensing electrodes.

15. The steering wheel device according to claim 14, wherein, in a transverse cross section of the holding sensing module perpendicular to the central axis, each of the left sensing electrodes has a first central angle relative to the central axis, each of the right sensing electrodes has a second central angle relative to the central axis, and each of the upper sensing electrodes has a third central angle relative to the central axis, and wherein a difference between the first central angle and the second central angle is less than or equal to 5 degrees.

16. The steering wheel device according to claim 14, wherein, in a transverse cross section of the holding sensing module perpendicular to the central axis, each of the left sensing electrodes has a first central angle relative to the central axis, each of the right sensing electrodes has a second central angle relative to the central axis, and each of the upper sensing electrodes has a third central angle relative to the central axis, and wherein the first central angle is within a range from 60 degrees to 180 degrees, and the third central angle is within a range from 60 degrees to 180 degrees.

17. A steering wheel device with hands-off detection (HOD), comprising:
a steering wheel having a manipulation ring defining a central axis, wherein the manipulation ring includes a left holding segment and a right holding segment; and
a holding sensing module assembled to the steering wheel and including:
a plurality of left sensing electrodes each having an elongated shape and disposed on the left holding segment of the manipulation ring, wherein the left sensing electrodes have a same width and are staggered with each other;
a plurality of left bridge electrodes, wherein each of the left bridge electrodes is connected in-between two of the left sensing electrodes adjacent to each other so as to be jointly defined as one of a plurality of first left electrodes, and any one of the left sensing electrodes not connected to any one of the left bridge electrodes is defined as one of a plurality of second left electrodes, and wherein any two of the first left electrodes adjacent to each other are provided with one of the second left electrodes therebetween;
a plurality of right sensing electrodes each having an elongated shape and disposed on the right holding segment of the manipulation ring, wherein the right sensing electrodes have a same width and are staggered with each other;
a plurality of right bridge electrodes, wherein each of the right bridge electrodes is connected in-between two of the right sensing electrodes adjacent to each other so as to be jointly defined as one of a plurality of first right electrodes, and any one of the right sensing electrodes not connected to any one of the right bridge electrodes is defined as one of a plurality of second right electrodes, and wherein any two of the first right electrodes adjacent to each other are provided with one of the second right electrodes therebetween;
wherein the first left electrodes are respectively connected to the second right electrodes, and the second left electrodes are respectively connected to the first right electrodes.

18. The steering wheel device according to claim 17, wherein, in a transverse cross section of the holding sensing module perpendicular to the central axis, each of the left sensing electrodes has a first central angle relative to the central axis, and each of the right sensing electrodes has a second central angle relative to the central axis, and wherein a difference between the first central angle and the second central angle is less than or equal to 5 degrees.

19. The steering wheel device according to claim 17, wherein, in a transverse cross section of the holding sensing module perpendicular to the central axis, each of the left sensing electrodes has a first central angle relative to the central axis, and each of the right sensing electrodes has a second central angle relative to the central axis, and wherein the first central angle is within a range from 90 degrees to 270 degrees.

20. The steering wheel device according to claim 17, wherein, in each of the first left electrodes, a length of the left bridge electrode is within a range from 0.01% to 10% of a length of any one of the two left sensing electrodes, and wherein, in each of the first right electrodes, a length of the right bridge electrode is within a range from 0.01% to 10% of a length of any one of the two right sensing electrodes.
